(19) United States
(12) Patent Application Publication
(10) Pub. No.: US 2014/0373504 A1
(43) Pub. Date: Dec. 25, 2014

(54) GAS TURBINE HAVING AN EXHAUST GAS DIFFUSER AND SUPPORTING FINS

(71) Applicant: Siemens Aktiengesellschaft, Munich (DE)

(72) Inventors: Marc Broker, Dinslaken (DE); Tobias Buchal, Dusseldorf (DE)

(73) Assignee: SIEMENS AKTIENGESELLSCHAFT, Munich (DE)

(21) Appl. No.: 14/376,429

(22) PCT Filed: Jan. 15, 2013
(86) PCT No.: PCT/EP2013/050610

§ 371 Date: Aug. 3, 2014

(30) Foreign Application Priority Data
Feb. 28, 2012 (EP) 12157273.9

(51) Int. Cl. F01D 25/30

(52) U.S. Cl. CPC F01D 25/305; F05D 2210/34; F05D 2270/102
USPC 60/39.5

(57) ABSTRACT

A gas turbine having an exhaust gas diffuser connected to a turbine unit is provided, wherein the gas diffuser channel of the gas diffuser is delimited on the outside by a channel wall and has a plurality of hollow supporting fins extending inward for fastening a radial bearing of the gas turbine, wherein at least one blow-off line for blow-off air having at least one pipeline ends at the outlet side on the exhaust gas diffuser and the end of the exhaust gas diffuser on the inlet side is connected to a compressor of the gas turbine. In order to at least partially compensate for incorrect incident flow of the supporting fins, more particularly in partial load operation, the supporting fins have a hub on the inner end thereof, the axial end of said hub having additional openings for blowing out the blow-off air in the diffuser channel.

### CROSS REFERENCE TO RELATED APPLICATIONS

This application is the US National Stage of International Application No. PCT/EP2013/050610 filed Jan. 15, 2013, and claims the benefit thereof. The International Application claims the benefit of European Application No. EP12157273 filed Feb. 28, 2012. All of the applications are incorporated by reference herein in their entirety.

### FIELD OF INVENTION

The invention relates to a gas turbine having an exhaust gas diffuser which adjoins a turbine unit, whose diffuser duct is outwardly bounded by a wall and on which there are provided a number of inward-extending hollow supporting fins for attaching a radial bearing of the gas turbine, wherein at least one blow-off line, comprising pipes, for blow-off air ends on the outflow side at the exhaust gas diffuser, the inflow-side end of which line is connected to a compressor of the gas turbine.

### BACKGROUND OF INVENTION

Gas turbines and their operating modes are very well known from the comprehensive available prior art. They always comprise, as part of an exhaust gas path, an exhaust gas diffuser through which the exhaust gas flowing out of the gas turbine can be forwarded. The exhaust gas is either fed to a chimney, if the gas turbine is provided for simple cycle operation, or, in the case of a combined cycle power plant, is fed by the exhaust gas path to a boiler by means of which the thermal energy contained in the exhaust gas is converted into steam for a steam turbine.

The operating point of the exhaust gas diffuser depends, first of all, on its volume flow rate which is principally influenced, as is known, by the ambient temperature, the compressor inlet guide vane setting and the firing temperature.

The exhaust gas diffuser should satisfy a number of requirements: on one hand, maximum pressure recovery is necessary in order to obtain maximum efficiency at the design point. At the same time, the efficiency should as far as possible decrease only slightly as one moves away from the design point. On the other hand, it should have no transient operational behavior which might otherwise impair the mechanical integrity of the power plant by vibration excitation. Furthermore, it should have a velocity distribution at the outlet which is as even as possible in order to achieve good boiler efficiency. Of equal importance is the avoidance of flip-flop effects when changing the operating point during low partial load operation. Finally, the exhaust gas diffuser should in addition also be compact and thus cost-effective.

Of particular importance for an optimum diffuser flow is the avoidance of regions of separated flow and reverse flow, both on the outer wall and at the transition from the exhaust gas diffuser to the boiler inlet. If these still arise, they should be of comparatively small magnitude. The separations on the inner surface of the smooth diffuser outer wall are mostly caused by a local flow energy which is too low and is not able to counteract the rising pressure downstream. The root cause of this is, in addition to the opening angle of the diffuser, the flow leaving the last turbine rotor blade row and, in particular, the leakage flow at the blade tips thereof. Regions of reverse flow may form, where relevant, in partial load operation, in particular behind the hub and at the outer wall. In that context, they may extend far enough downstream that there are regions of upstream flow even in the region of the boiler inlet. Where afterburners are used, reverse flow can generate a flashback which could restrict the combined operating mode of gas turbines and afterburners.

In order to counteract these aerodynamic phenomena, it is known to supply parts of the compressor mass flow rate directly to the diffuser flow, via compressor takeoffs and a plurality of blow-off lines, when the gas turbine is operated at partial load. In that context, the openings of the blow-off lines in the diffuser are generally optimized in terms of cost, such that these are generally arranged diagonally on the surface of the diffuser. Blowing out at few circumferential positions also gives rise to cold veins within the diffuser flow. In conjunction with a transient flow in the diffuser, this leads to a transient thermal load on the diffuser walls and thus promotes the formation of cracks in that region.

### SUMMARY OF INVENTION

An object of the invention is therefore to propose a gas turbine having an exhaust gas diffuser which adjoins a turbine unit, and which can counteract the problems noted in the prior art.

This object relating to the gas turbine is achieved with a gas turbine according to the features of the independent claims. Advantageous configurations are indicated in the subclaims and may be combined with one another in any manner.

It is provided according to aspects of the invention that the outflow-side end of the blow-off line is fluidically connected to the hub via the cavity of the supporting fins so as to forward blow-off air into the hub and the blow-off air is blown out on the hub side in order to reduce the reverse flow region behind the hub or in order to reduce, in the manner of a Coand\check{a} jet, the tendency to separation at a hub end which may be conical.

According to one advantageous embodiment, the outflow-side end of the blow-off line is fluidically connected to the cavity of the supporting fins, with the supporting fins having openings for blowing out the blow-off air into the diffuser duct. By guiding the blow-off air into the supporting fins of the rear bearing star and the blowing out of this air preferably carried out at the trailing edge of the supporting fins, the blow-off air can be used in a targeted manner during partial load operation to reduce the separations at the supporting fins which are then intensely subject to incorrect incident flow. Furthermore, the bearing star formed by the supporting fins, and parts of the former such as its sheet metal cladding, may thus be cooled in a targeted manner. This makes it possible to raise the turbine outlet temperature during operation at partial load, in comparison with operation at rated power, by means of which, during operation at partial load, it is in turn possible to counteract the drop in flame temperature and the associated increase in the CO values of the exhaust gas.

It is to be noted that blowing out the blow-off air through the openings arranged in the supporting fins may also be provided independently of blowing out through the hub.

### BRIEF DESCRIPTION OF THE DRAWINGS

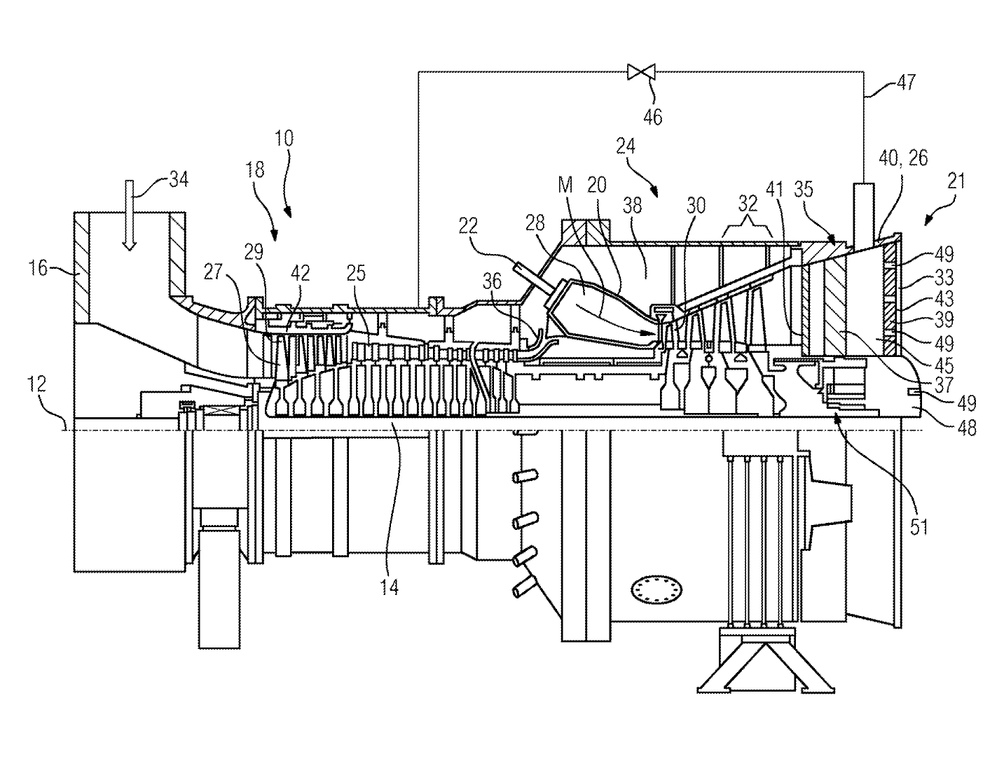

The invention will be explained in more detail with reference to a single FIGURE. The single exemplary embodiment in FIG. 1 shows a gas turbine in partial longitudinal section.

### DETAILED DESCRIPTION OF INVENTION

FIG. 1 shows a stationary gas turbine 10 in a partial longitudinal section. The gas turbine 10 has inside it a rotor 14 which is rotationally mounted about an axis of rotation 12 and which is also designated as a turbine rotor. An intake casing 16, an axial turbocompressor 18, a toroidal annular combustion chamber 20 with a plurality of burners 22 arranged rotationally symmetrically to one another, a turbine unit 24 and a turbine outlet casing 26 succeed one another along the rotor 14. A turbine exhaust gas distributor (not shown in more detail) attaches to the turbine outlet casing 26 of the gas turbine 10. Both components are part of the gas turbine exhaust gas diffuser 21. In place of the annular combustion chamber, the gas turbine may also be fitted with a plurality of tubular combustion chambers.

The axial turbocompressor 18 comprises an annularly designed compressor duct with compressor stages succeeding one another in cascade in the latter and composed of moving blade and guide blade rings. The moving blades 27 arranged on the rotor 14 lie with their freely ending airfoil tips opposite an outer duct wall of the compressor duct. The compressor duct issues via a compressor outlet diffuser 36 in a plenum 38. Provided in the latter is the annular combustion chamber 20 with its combustion space 28 which communicates with an annular hot gas duct 30 of the turbine unit 24. Four turbine stages 32 connected in series are arranged in the turbine unit 24. A generator or a working machine (not illustrated in either case) is coupled to the rotor 14.

A turbine exhaust gas distributor adjoins the turbine outlet casing 26 of the gas turbine 10. Both components are part of the gas turbine exhaust gas diffuser 21. An exhaust gas gas system (also not shown in more detail) is provided downstream of the turbine exhaust gas distributor. This exhaust gas gas system and the gas turbine exhaust gas diffuser 21 form the exhaust gas diffuser system.

A diffuser duct 33, which is annular on the inflow side and is bounded on the radially outward side by a conical duct wall 40, is provided in the gas turbine exhaust gas diffuser 21. Six supporting fins 35 are distributed about the circumference of the diffuser duct 33, on the duct wall 40, of which fins only one is shown in longitudinal section. A different number of supporting fins may equally be present. Each supporting fin 35 has, inside it, a stay 37 which is protected from direct contact with exhaust gas by means of a sheet metal cladding 39. The sheet metal cladding 39 has a leading edge 41 and a trailing edge 43, having in cross section an aerodynamic profile similar to the profile contour of a blade airfoil of a compressor blade. A hub 48 is arranged at the inner ends of the supporting fins 35 and forms a casing for a turbine-side radial bearing 51 arranged therein. Despite the stay 37, a cavity 45 is also present within the sheet metal cladding 39. Part of the compressor mass flow rate can be fed to this cavity via a blow-off line 47. The blow-off line 47 comprises three pipes, of which only one pipe is represented. More than three pipes—or fewer—may equally be provided. The pipes not shown are distributed about the circumference of the gas turbine 10. In addition, a valve is provided in each pipe as a control member 46 for closing and either partially or fully opening the pipes. All of the pipes connect the compressor 18 or the plenum 38 to the cavities 45 in order to supply blow-off air to these.

A plurality of openings 49 is provided in the trailing edge 43 of the supporting fin 35 and/or in the downstream region of the convex suction side of the supporting fins 35, via which openings the blow-off air fed to the supporting fin 35 may be injected into the diffuser duct 33. Also independently of the presence of the openings 49 in the supporting fins 35, openings 49 for blowing out blow-off air may be provided in the hub 48. In particular, the latter configuration is well suited to avoiding reverse flow regions downstream of the hub 48.

When the gas turbine 10 is in operation, the axial turbocompressor 18 sucks in through the intake casing 16 ambient air 34 as the medium to be compressed and compresses this ambient air. The compressed air is routed through the compressor outlet diffuser 36 into the plenum 38, from where it flows into the burners 22. Fuel also passes via the burners 22 into the combustion space 28. The fuel is burnt there, with the addition of the compressed air, to form a hot gas M. The hot gas M subsequently flows into the hot gas duct 30 where it expands, so as to perform work, at the turbine blades of the turbine unit 24. The energy meanwhile released is absorbed by the rotor 14 and is utilized, on the one hand, for driving the axial turbocompressor 18 and, on the other hand, for driving a working machine or electric generator.

The operation of the gas turbine 10 is configured such that, during operation at rated power, only that amount of blow-off air which is required to avoid the exhaust gas penetrating into the openings 49 flows out of the openings 49. If the power given off by the gas turbine is decreased to below a predetermined value, the control members 46 arranged in the blow-off line 47 are reopened, such that the blow-off mass flow rate increases significantly. The predetermined value may be for example 80%, 70%, 50% or any other proportion of the gas turbine rated power. By means of this measure, it is possible, on one hand, to avoid separations at the supporting fins 35, which may arise during partial load operation due to incorrect incident flow because of a reduced exhaust gas mass flow rate. In addition, the percentage proportion of combustion air in the fuel-air mixture is reduced, which leads to a higher combustion temperature and can keep CO emissions at a lower level. By blowing out the blow-off air through the hub 48, it is also possible to avoid reverse flow regions downstream of the hub 48.

In all, the invention proposes a gas turbine 10 having an exhaust gas diffuser 21 which adjoins a turbine unit 24, whose diffuser duct 33 is outwardly bounded by a duct wall 40 and on which there are provided a number of inward-extending hollow supporting fins 35 for attaching a radial bearing 51 of the gas turbine 10, wherein at least one blow-off line 47, comprising pipes, for blow-off air ends on the outflow side at the exhaust gas diffuser 21, the inflow-side end of which line is connected to a compressor 18 of the gas turbine 10. In order in particular during partial load operation to compensate, at least in part, for the loss of efficiency caused by the incorrect incident flow on the supporting fins 35, it is provided that the supporting fins 35 have at their inner end a hub 48, at the axial end of which further openings 49 are provided for blowing out the blow-off air into the diffuser duct.

1-4. (canceled)

5. A gas turbine, comprising:
an exhaust gas diffuser which adjoins a turbine unit, whose diffuser duct is outwardly bounded by a duct wall and having a number of inward-extending hollow supporting fins thereon for attaching a radial bearing of the gas turbine,
at least one blow-off line, comprising pipes, for blow-off air that ends on the outflow side at the exhaust gas diffuser, the inflow-side end of which line is connected to a compressor of the gas turbine,
wherein the supporting fins have, at their inward end, a hub which is fluidically connected, via the cavity of the respective supporting fin, to the outflow-side end of the blow-off line, and
wherein openings for blowing out the blow-off air into the diffuser duct are provided at the axial, outflow-side end of the hub.

6. The gas turbine as claimed in claim 5, wherein the supporting fins have further openings for blowing out the blow-off air into the diffuser duct.

7. The gas turbine as claimed in claim 6, wherein the further openings on the supporting fins are distributed only on the hub side.

8. The gas turbine as claimed in claim 6, wherein the further openings are arranged on a trailing edge of the supporting fins and/or in the downstream region of the convex suction side of the supporting fins.
